(19) United States
(12) Patent Application Publication
(10) Pub. No.: US 2004/0078360 A1
(43) Pub. Date: Apr. 22, 2004

(54) Data locking system and method for medical system architecture

(76) Inventor: Randy DeFauw, San Diego, CA (US)

Correspondence Address: Richman and Associates, PO Box 3333, La Jolla, CA, 92038-3333, US

(21) Appl. No.: 10/278,959

(22) Filed: Oct. 22, 2002

(51) Int. Cl. G06F 7/00

(52) U.S. Cl. 707/3

(57) ABSTRACT

A system and method for controlling access to data in a first database for a plurality of users that includes maintaining a master data lock database separate from the first database where when a data lock request from one of the plurality of users is received, the data lock database is evaluated to determine whether the requested data lock is available and when the data lock is available the data lock database is updated to indicate that requesting user is the current owner of the data lock.

### BACKGROUND OF THE INVENTION

1. Field of the Invention

This invention relates to shared database access control systems and methods, and more particularly to database access control systems and methods enabling multiple users to access and update records in shared databases.

2. Description of Related Art

In system architecture having one or more databases and multiple users, users may want contemporaneously access to data within the one or more databases. A need exists for a low overhead system and method that enables multiple users to access data within one or more databases.

### SUMMARY OF THE INVENTION

The present invention includes apparatus and a method for controlling access to data in a first database for a plurality of users. The method includes maintaining a master data lock database separate from the first database. When a data lock request from one of the plurality of users is received, the data lock database is evaluated to determine whether the requested data lock is available. When the data lock is available the data lock database is updated to indicate that requesting user is the current owner of the data lock.

The method may also search the data lock database to determine whether a data lock records exists for the requested data lock. In addition, the method may maintain a separate user data lock database separate from the first database and master database for each of the plurality of users. Further, the method may inform the requesting user that the data lock request has been granted when it has been determined that it is available and may also inform the requesting user that the data lock request has been denied when it has been determined that it is not available. The method may also search the data lock database to determine whether a data lock records exists for the requested data lock, determine whether the data lock record has expired, and indicate that the data lock is available when the data lock record has been determined to be expired.

The method may also determine whether the data lock record has existed for a predetermined period of time when the data lock record exists for the requested data lock and indicate that the data lock record is available when the data lock record has existed for at least the predetermined period of time. In another embodiment, each data lock request may include a requesting user identification and each user may have an associated priority. The method may determine whether the data lock record current owner's associated priority is less than the requesting user's associated priority and indicate that the data lock record is available when the data lock record current owner's associated priority is less than the requesting user's associated priority.

### BRIEF DESCRIPTION OF THE DRAWINGS

FIG. 1 is a block diagram of exemplary client service provider related AR architecture in which the present invention may be employed.

FIG. 2 is a block diagram of an exemplary central AR data processing system shown in FIG. 1.

FIG. 3A is a block diagram of an exemplary Data Locking processing system shown in FIG. 1.

FIG. 3B is a block diagram of data locking servlet software processes that may exist in the Data Locking processing system shown in FIG. 3A.

FIG. 4 is a flowchart of an exemplary client data locking servlet process in accordance with the present invention.

FIG. 5 is a flowchart of an exemplary master data locking servlet process in accordance with the present invention.

Like reference numbers and designations in the various drawings indicate like elements.

### DETAILED DESCRIPTION OF THE PREFERRED EMBODIMENTS

Throughout this description, the preferred embodiment and examples shown should be considered as exemplars, rather than as limitations on the present invention.

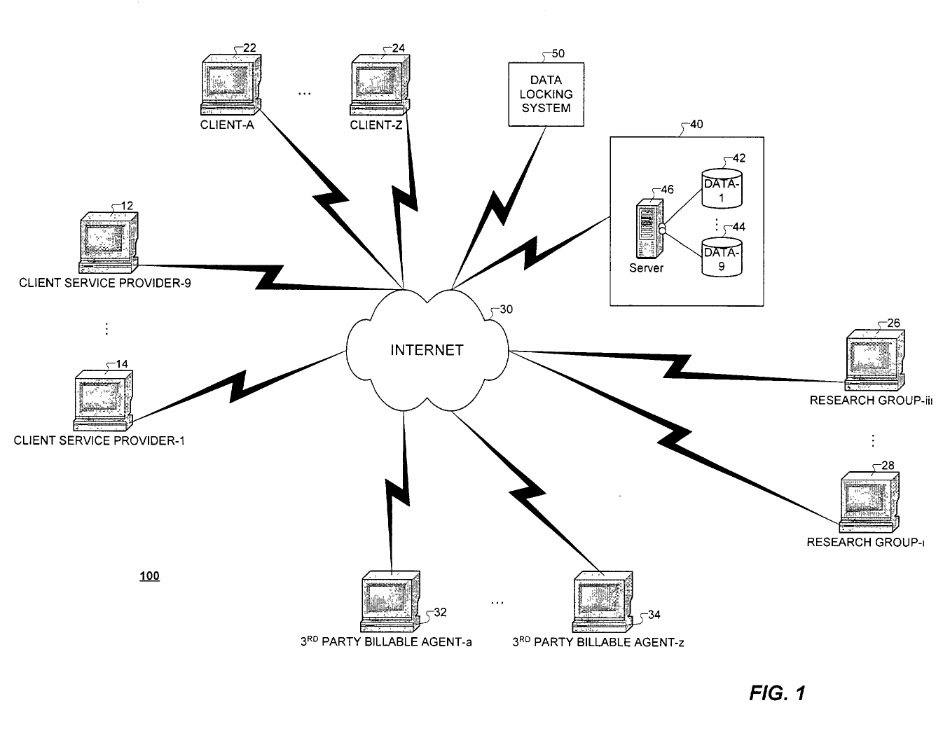

FIG. 1 is a block diagram of an exemplary client service provider AR architecture 100 in which the present invention may be employed. The architecture 100 includes a plurality of client service request/order entry systems (“COE”) 22, 24, a plurality of client service request/order entry processing systems (“SOEP”) 12, 14, a plurality of third party billable agent systems (“BAS”) 32, 34, a plurality of research group systems (“RGS”) 26, 28, and a Data Locking System (“DLS”) 50 coupled to a central AR data processing system (“CARS”) 40 via a network of networks or Internet 30. In one exemplary embodiment a user of a COE 22, 24 may generate or modify a service request using an order entry program maintained on the CARS 40. When an order entry is submitted at a COE 22, 24, the data is maintained in one or more databases located on a data storage device 42, 44 in the CARS 40. A SOEP 12, 14 may also perform order entry/modification and receive service requests from COE 22, 24 via the CARS 40. A SOEP 12, 14 may indicate when a service request is completed via the CARS 40. The CARS 40 may then generate and transmit a request for payment for the rendered service to an appropriate BAS 32, 34. The CARS 40 may direct a RGS 26, 28 to search for information related to a processed service request.

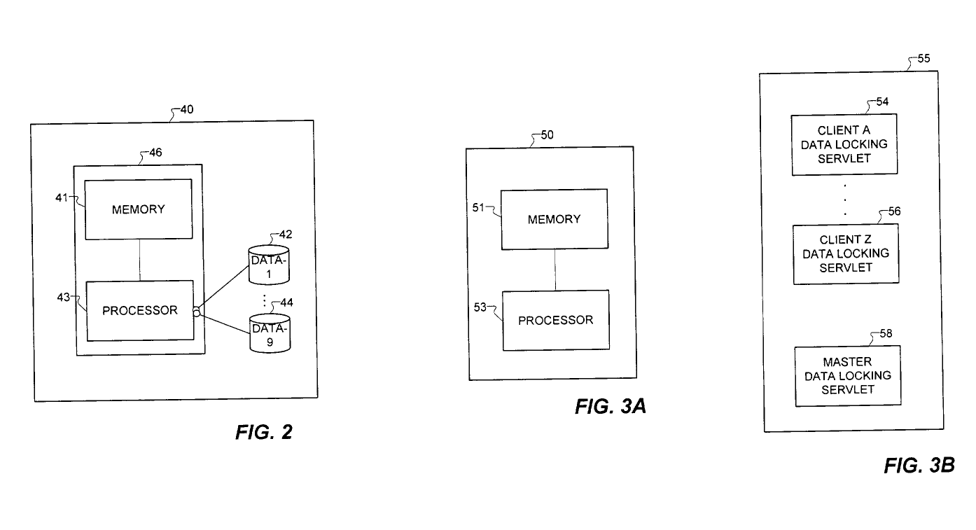

FIG. 2 is a block diagram of an exemplary CARS 40. The CARS 40 includes a server 46 and plurality of data storage devices 42, 44 such as optical, magnetic, or other permanent data storage devices. The CARS 40 stores databases on the storage devices 42, 44 where the databases are used to maintain and process service requests. The CARS 40 may also store program files on the storage devices 42, 44 where the program files include executable instructions for processing service requests and enabling the COE 22, 24 and SOEP 12, 14 to process service requests. The CARS 40 server 46 includes a memory 41 coupled to a processor 43 where the processor is also coupled to the storage devices 42, 44. The processor 43 executes program instructions for processing service requests and supporting COE 22, 24 and SOEP 12, 14. The memory 41 stores data and program instructions where the data may include service requests and information related to the requests that may be stored in a database on a storage device 42, 44.

FIG. 3A is a block diagram of an exemplary DLS 50. The DLS 50 includes a memory 51 coupled to a processor 53. In another exemplary embodiment, the DLS 50 may also include storage devices (not shown) coupled to the processor 53. FIG. 3B is a block diagram of data locking servlet software instances that the processor 53 may be executing. The data locking servlet instances may includes a plurality of client servlet instances (A to Z) 54 to 56 and a master servlet instance 58. In one exemplary embodiment, each client servlet executing in the DLS 50 corresponds to a user on a COE 22, 24, SOEP 12, 14, BAS 32, 34, or RGS 26, 28.

An exemplary DLS 50 is explained in detail with reference to an application of the system 100 to a particular client service and client paradigm. In this example, the client service providers 12, 14 are a plurality of medical laboratories, the clients are physicians that order laboratory tests for patients, and the billable agents are patient's medical insurance providers. Accordingly in this example, a physician via one of the plurality of COE 22, 24 may order one or more laboratory tests from a laboratory. One or more laboratories may also enter, modify or process orders via a SOEP 12, 14. Further, other parties may receive data, review data, or update order entry related data including billing data via a BAS 32, 34, or RGS 26, 28. In the exemplary embodiment, all related data is centrally maintained in one or more databases located in the CARS 40. Given the possibility of contemporaneously requested access to data within these databases, the present invention employs the DLS 50 to control access to the data within these databases. The CARS 40 does not maintain data locks for the databases within storage 42, 44 to limit the overhead of the CARS 40 to transmitting data and pages as requested by users.

In the present invention, the DLS 50 generates/executes a client data locking servlet 54, 56 for each user along with a master data locking servlet. Each client data locking servlet 54, 56 also includes a local data lock database/table that is stored in the memory 53. The master data locking servlet maintains a master data lock database/table that is also stored in the memory 53. Accordingly, data locks for data located in a database 42, 44 of the CARS 40 are stored and maintained in a separate data processing system, the DLS 50. This enables the CARS 40 to efficiently process data requests without data locking overhead. Further, in an exemplary embodiment of the present invention, requests for data locks and releases of data locks (from users) and data locks grants and denials (from the DLS 50) are communicated in system architecture 100 using a low overhead messaging system. In an exemplary embodiment, data locking related messages are communicated in architecture 100 using a Java™ Messaging Service (“JMS”).

JMS is an application program interface (API) from Sun Microsystems (Sun®) of Palo Alto, Calif., that supports formal communication, known as messaging, between computer systems in a network. Sun's JMS provides a common interface to standard messaging protocols and also to special messaging services in support of Java programs. The use of messaging for data locking control allows the user's various systems COE, SOEP, BAS, and RGS programs to share common message-handling code and facilitate communication even if they employ different programming environments (languages, compilers, and operating systems) given each environment understands the common messaging format and protocol.

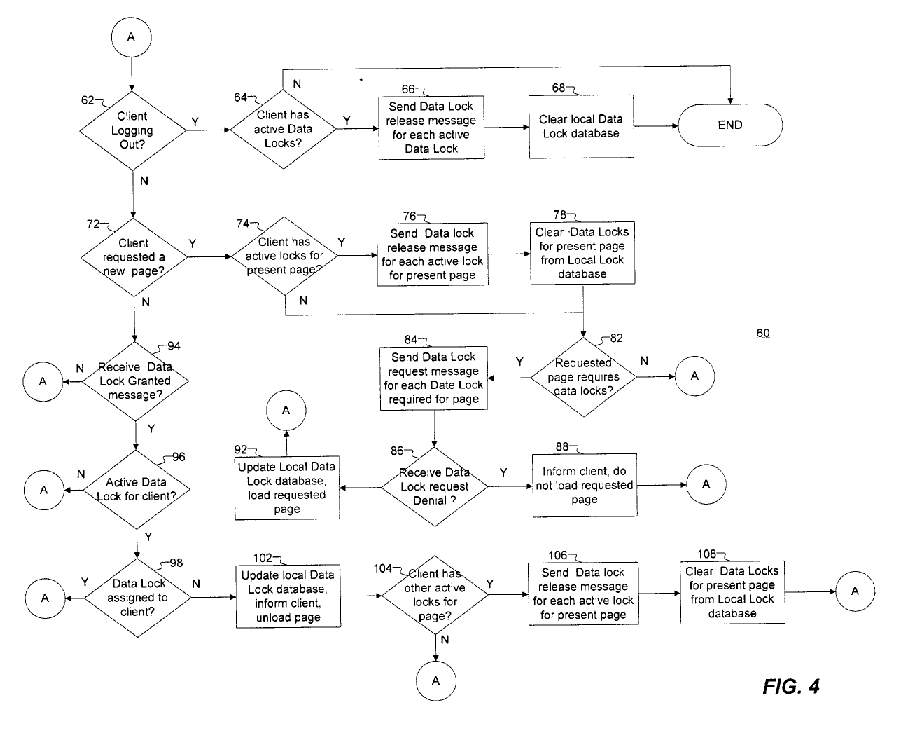

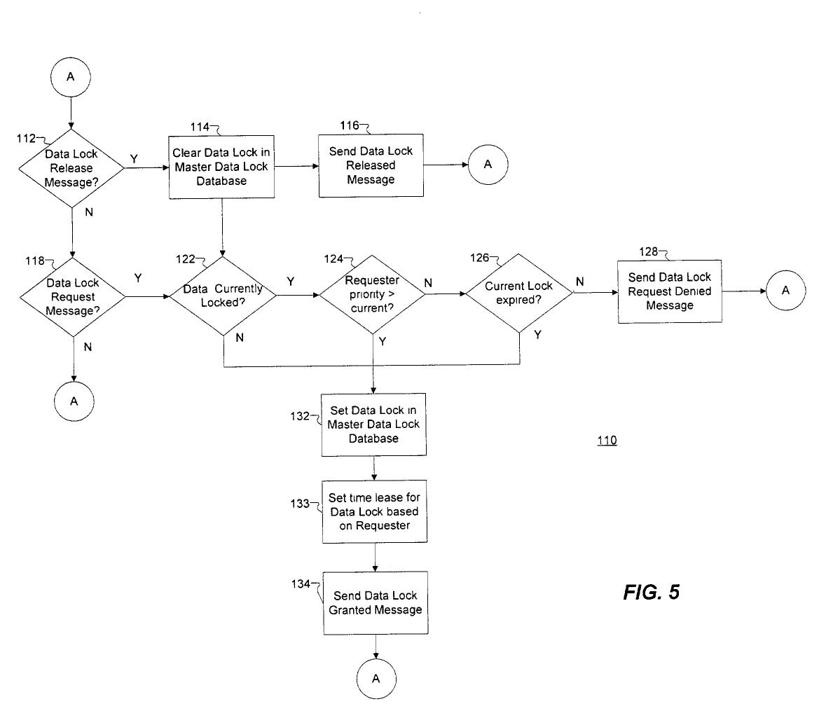

An exemplary client data locking servlet process and an exemplary master data locking servlet process are presented to FIGS. 4 and 5. FIG. 4 is a flowchart of the exemplary client data locking servlet process 60 in accordance with the present invention. In this exemplary embodiment, the process 60 determines whether a client is logging out (step 62), whether the client has requested a new page (step 72), or whether a data lock grant message has been received (step 94). In the exemplary embodiment, when a user logs into the CARS 40, a client data locking servlet 54, 56 is generated for the user with a local data locking database/table stored in the memory 51. When a user requests a page (step 72) (such as an order entry or review page for a new order or existing order), the page may include data stored in one or more records of a database 42, 44.

To ensure the client receives the most current data and to enable the client to update the data, other users/clients are ideally prevented from receiving the data or sending updates to the data when another user is reviewing the data (on a page). At step 72, when a client requests a new page (such as when the client logs in), several steps are performed. First the process 60 determines whether the client has any existing/active data locks for their current page (step 74), e.g., the client/user may be currently accessing one page and then request a new page where the current page required one or more data locks for the client.

The client servlet may review the data locks in its local data lock database/table to determine whether there are any active locks associated with the client's current page (step 74). When there are active data locks, the client servlet generates a data lock release message to be transmitted to the master servlet for each active lock. The data lock release message may include a data lock identifier (“ID”) and client ID. It is noted that in other exemplary embodiment, a client servlet may be processed on systems other than the DLS so that a JMS message to the master servlet may be needed to release a data lock or request a data lock. In the exemplary embodiment, the processor 53 transmits the data lock release or request from the client servlet to the master servlet.

The client servlet 78 then clears all active data locks for the client's current page (step 78). Then the client servlet process 60 determines whether the page to be loaded requires one or more data locks, i.e., includes data from one or more records located in the CARS 40 (step 82). The client servlet process 60 requests the data locks needed for the request page. In an exemplary the granularity of the data locks may be limited a record, one or more fields of a record, or a plurality of records where the data to be displayed or modified exists in one of the same. Step 84 of the client servlet process 60 generates and transmits a data lock request for the data on the requested page based on the granularity of the architecture 100 and the needed data. The data lock request (and data lock releases) are processed by the master servlet process 110. In one exemplary embodiment, the master servlet generates a data lock request denial when a data lock request can not be granted. In this embodiment, the client servlet process 60, requests the data needed for the page from the CARS 40, loads the requested page, and updates its local data lock database (step 92) unless it receives a data lock request denial (step 86). When a data lock request denial is received, the requested page is not loaded and the client is informed that the requested page is not currently available (step 88).

In another preferred embodiment, the client servlet process 60 waits for data lock granted messages for each data lock needed for the requested page. When all the requested data locks are not granted within a predetermined time interval, the requested page is not loaded and the client is informed that the requested page is not currently available. It is noted that in either embodiment, a client data lock request may include a data ID (of the data to be locked) and a client ID. In an exemplary embodiment, client's have an associated priority where some clients have higher priority than other clients. Accordingly, a client may be granted data locks needed for a page, receive the data and load the page based on their priority. Subsequently the client may lose a data lock needed for their current page when a client/user having a higher priority requests one of the data locks currently owned by the client.

As step 94, the client server process 60 receives a data lock granted message. The process 60 determines whether the data lock grant is related to a data lock the client currently owns. Step 96 of process 60 may review its local data lock database/table to determine whether it currently owns the data lock in the grant message. The data lock granted message may also indicate the client assigned the data lock. Step 98 of process determines whether the active data lock has been assigned to another client (such as to a client having higher priority). When this condition is true (active data lock assigned to another user), the client may not have the most current data on its page or be able to update the data. The client servlet 60 (at step 102), then unloads the page, informs the client the page is no longer available and removes the data lock from its local data lock database/table. The client servlet process 60 may also remove any other data locks associated with the unloaded page (if any—step 104) from its local data lock database (step 108) and send data lock database release messages for these other data locks (step 106).

When a client logs out (at step 62) the exemplary client servlet process 60 performs a series of steps (64, 66, and 68) similar to when the client requests a new page. When the client has active locks (step 64), the client servlet process 60 sends a data lock release message for each data lock (step 66) to the master servlet and clears its local data lock database (step 68). Then client servlet process 60 may then terminate. In another exemplary embodiment, the client servlet process 60 may generate and transmit a client logout message to the master servlet process 110 where the master servlet process then clears all locks associated with the client.

FIG. 5 is a flowchart of an exemplary master data locking servlet process 110 in accordance with the present invention. In this exemplary embodiment, the master servlet process 110 receives either data lock release or data lock request messages (step 112, step 118) and then processes the messages accordingly. When the master servlet process 110 receives a data lock release message (at step 112), the process 110 clear the data lock from the master data lock database (step 114). In an exemplary embodiment, the master servlet process 110 may generate a data lock released message to be transmitted to the client servlets. In this embodiment, the client servlets may include steps to notify an associated client that a page is now available that the client had previously unsuccessfully requested (due to the data lock indicated as now released in the data lock released message from the master servlet process 110).

When the master servlet process 110 receives a data lock request message (step 118), the process 110 may first determine whether the data is currently locked by reviewing it master data lock database stored in the memory 51. The data lock request message may also include the requesting client's ID. In an exemplary embodiment, the request message may further include the requesting client's ID data locking priority. In another embodiment, the master servlet process 110 may determine the client's data locking priority by retrieving it from a table/database stored in the CARS 40. The process 110, may then determine whether the requestor's priority is greater than the priority of the current holder of the requested data lock (step 124). In addition, the master servlet process may determine whether the current data lock has expired (step 126). In one embodiment, a data lock expires after a predetermined time interval has elapsed since the data lock was granted. In particular, in one embodiment at step 133, each lock is assigned a limited time lease that varies in length (time interval) as a function of the requester. For non-administrative requesters, the time lease may be 5 minutes and for administrative requesters, the time lease may be 60 minutes in one exemplary embodiment.

When the requested data lock is not present in the master data lock database, the requestor's priority is greater than the current data lock holder's priority, or the data lock has expired, the master servlet process 110 may update its master data lock database to indicate that the requestor is now the current data lock holder (step 132) (and the time lease/interval for the data lock). In an exemplary embodiment, the master servlet process 110 stores the current holder's ID, their priority, and the time of the grant in a record of the data lock database associated with the data lock. In another embodiment, the client priority is not stored but retrieved from the CARS 40 each time a comparison is needed. Then, the master servlet process sends a data lock granted message to each client servlet (step 134).

When a lock exists, is not expired, and the current holder's priority is greater than or equal to the requestor's priority, the master servlet process 110 may generate and transmit a data lock request denied message to the requesting client servlet (at step 128). Thus, the master servlet process 110 and plurality of client servlets 54, 56 enable clients to receive and update the latest data in the CARS 40.

While this invention has been described in terms of a best mode for achieving this invention's objectives, it will be appreciated by those skilled in the art that variations may be accomplished in view of these teachings without deviating from the spirit or scope of the present invention. For example, the present invention may be implemented using any combination of computer programming software, firmware or hardware (e.g., a software language, such as C++ or others may be used to implement the invention). As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc. or by transmitting the code on a network for remote execution.

What is claimed is:

1. A method of controlling access to data in a first database for a plurality of users, comprising the steps of:
a) maintaining a master data lock database separate from the first database;
b) receiving a data lock request from one of the plurality of users;
c) evaluating the data lock database to determine whether the requested data lock is available; and
d) updating the data lock database to indicate that requesting user is the current owner of the data lock when the data lock is available.

2. The method of claim 1, wherein step c) includes searching the data lock database to determine whether a data lock records exists for the requested data lock.

3. The method of claim 2, further comprising the step of maintaining a separate user data lock database separate from the first database and master database for each of the plurality of users.

4. The method of claim 2, further comprising the step of informing the requesting user that the data lock request has been granted when it has been determined that it is available.

5. The method of claim 3, further comprising the step of informing the requesting user that the data lock request has been denied when it has been determined that it is not available.

6. The method of claim 4, further comprising the steps of:
i) maintaining a separate user data lock database separate from the first database and master database for each of the plurality of users; and
ii) when a user is informed that a requested data lock has been granted adding the data lock to the corresponding separate user data lock database.

7. The method of step 1, wherein step c) includes the steps of:
i) searching the data lock database to determine whether a data lock records exists for the requested data lock;
ii) determining whether the data lock record has expired when a data lock record is present for the requested data lock; and
iii) indicating the data lock is available when the data lock record has been determined to be expired.

8. The method of claim 7, further comprising the step of maintaining a separate user data lock database separate from the first database and master database for each of the plurality of users.

9. The method of claim 7, further comprising the step of informing the requesting user that the data lock request has been granted when it has been determined that it is available.

10. The method of claim 8, further comprising the step of informing the requesting user that the data lock request has been denied when it has been determined that it is not available.

11. The method of claim 9, further comprising the steps of:
i) maintaining a separate user data lock database separate from the first database and master database for each of the plurality of users; and
ii) when a user is informed that a requested data lock has been granted adding the data lock to the corresponding separate user data lock database.

12. The method of step 1, wherein step c) includes the steps of:
i) searching the data lock database to determine whether a data lock records exists for the requested data lock wherein each data lock record includes the time the lock was granted;
ii) determining whether the data lock record has existed for a predetermined period of time when the data lock record exists for the requested data lock; and
iii) determining the data lock record is available when the data lock record has existed for at least the predetermined period of time.

13. The method of claim 12, further comprising the step of maintaining a separate user data lock database separate from the first database and master database for each of the plurality of users.

14. The method of claim 12, further comprising the step of informing the requesting user that the data lock request has been granted when it has been determined that it is available.

15. The method of claim 13, further comprising the step of informing the requesting user that the data lock request has been denied when it has been determined that it is not available.

16. The method of claim 14, further comprising the steps of:
i) maintaining a separate user data lock database separate from the first database and master database for each of the plurality of users; and
ii) when a user is informed that a requested data lock has been granted adding the data lock to the corresponding separate user data lock database.

17. The method of step 1, wherein the data lock request includes an identification of the requesting user and the user has an associated priority and wherein step c) includes the steps of:
i) searching the data lock database to determine whether a data lock records exists for the requested data lock wherein each data lock record includes an identification of current owner and each current owner has an associated priority;
ii) determining whether the data lock record current owner's associated priority is less than the requesting user's associated priority when the data lock record exists for the requested data lock; and
iii) determining the data lock record is available when the data lock record current owner's associated priority is less than the requesting user's associated priority.

18. The method of claim 17, further comprising the step of maintaining a separate user data lock database separate from the first database and master database for each of the plurality of users.

19. The method of claim 17, further comprising the step of informing the requesting user that the data lock request has been granted when it has been determined that it is available.

20. The method of claim 18, further comprising the step of informing the requesting user that the data lock request has been denied when it has been determined that it is not available.

21. The method of claim 19, further comprising the steps of:
i) maintaining a separate user data lock database separate from the first database and master database for each of the plurality of users; and
ii) when a user is informed that a requested data lock has been granted adding the data lock to the corresponding separate user data lock database.

22. The method of step 1, wherein the data lock request includes an identification of the requesting user and the user has an associated priority and wherein step c) includes the steps of:
i) searching the data lock database to determine whether a data lock records exists for the requested data lock wherein each data lock record includes an identification of current owner and the time the lock was granted and each current owner has an associated priority;
ii) determining whether the data lock record has existed for a predetermined period of time when the data lock record exists for the requested data lock;
iii) determining the data lock record is available when the data lock record has existed for at least the predetermined period of time
iv) determining whether the data lock record current owner's associated priority is less than the requesting user's associated priority when the data lock record exists for the requested data lock; and
v) determining the data lock record is available when the data lock record current owner's associated priority is less than the requesting user's associated priority.

23. The method of claim 22, further comprising the step of maintaining a separate user data lock database separate from the first database and master database for each of the plurality of users.

24. The method of claim 22, further comprising the step of informing the requesting user that the data lock request has been granted when it has been determined that it is available.

25. The method of claim 23, further comprising the step of informing the requesting user that the data lock request has been denied when it has been determined that it is not available.

26. The method of claim 24, further comprising the steps of:
i) maintaining a separate user data lock database separate from the first database and master database for each of the plurality of users; and
ii) when a user is informed that a requested data lock has been granted adding the data lock to the corresponding separate user data lock database.

27. An apparatus for controlling access to data in a first database for a plurality of users, comprising:
a) means for maintaining a master data lock database separate from the first database;
b) means for receiving a data lock request from one of the plurality of users;
c) evaluating means for evaluating the data lock database to determine whether the requested data lock is available; and
d) means for updating the data lock database to indicate that requesting user is the current owner of the data lock when the data lock is available.

28. The apparatus of claim 27, wherein the evaluation means includes means for searching the data lock database to determine whether a data lock records exists for the requested data lock.

29. The apparatus of claim 28, further comprising means for maintaining a separate user data lock database separate from the first database and master database for each of the plurality of users.

30. The apparatus of claim 28, further comprising means for informing the requesting user that the data lock request has been granted when it has been determined that it is available.

31. The apparatus of claim 29, further comprising means for informing the requesting user that the data lock request has been denied when it has been determined that it is not available.

32. The apparatus of claim 30, further comprising:
i) means for maintaining a separate user data lock database separate from the first database and master database for each of the plurality of users; and
ii) means for when a user is informed that a requested data lock has been granted adding the data lock to the corresponding separate user data lock database.

33. The apparatus of step 27, wherein the evaluation means includes:
i) means for searching the data lock database to determine whether a data lock records exists for the requested data lock;
ii) means for determining whether the data lock record has expired when a data lock record is present for the requested data lock; and
iii) means for indicating the data lock is available when the data lock record has been determined to be expired.

34. The apparatus of claim 33, further comprising means for maintaining a separate user data lock database separate from the first database and master database for each of the plurality of users.

35. The apparatus of claim 33, further comprising means for informing the requesting user that the data lock request has been granted when it has been determined that it is available.

36. The apparatus of claim 34, further comprising means for informing the requesting user that the data lock request has been denied when it has been determined that it is not available.

37. The apparatus of claim 35, further comprising:
i) means for maintaining a separate user data lock database separate from the first database and master database for each of the plurality of users; and
ii) means for when a user is informed that a requested data lock has been granted adding the data lock to the corresponding separate user data lock database.

38. The apparatus of step 27, wherein the evaluation means includes:
i) means for searching the data lock database to determine whether a data lock records exists for the requested data lock wherein each data lock record includes the time the lock was granted;
ii) means for determining whether the data lock record has existed for a predetermined period of time when the data lock record exists for the requested data lock; and
iii) means for determining the data lock record is available when the data lock record has existed for at least the predetermined period of time.

39. The apparatus of claim 38, further comprising means for maintaining a separate user data lock database separate from the first database and master database for each of the plurality of users.

40. The apparatus of claim 38, further comprising means for informing the requesting user that the data lock request has been granted when it has been determined that it is available.

41. The apparatus of claim 39, further comprising means for informing the requesting user that the data lock request has been denied when it has been determined that it is not available.

42. The apparatus of claim 40, further comprising:
i) means for maintaining a separate user data lock database separate from the first database and master database for each of the plurality of users; and
ii) means for when a user is informed that a requested data lock has been granted adding the data lock to the corresponding separate user data lock database.

43. The apparatus of step 27, wherein the data lock request includes an identification of the requesting user and the user has an associated priority and wherein the evaluation means includes:
i) means for searching the data lock database to determine whether a data lock records exists for the requested data lock wherein each data lock record includes an identification of current owner and each current owner has an associated priority;
ii) means for determining whether the data lock record current owner's associated priority is less than the requesting user's associated priority when the data lock record exists for the requested data lock; and
iii) means for determining the data lock record is available when the data lock record current owner's associated priority is less than the requesting user's associated priority.

44. The apparatus of claim 43, further comprising means for maintaining a separate user data lock database separate from the first database and master database for each of the plurality of users.

45. The apparatus of claim 43, further comprising means for informing the requesting user that the data lock request has been granted when it has been determined that it is available.

46. The apparatus of claim 44, further comprising means for informing the requesting user that the data lock request has been denied when it has been determined that it is not available.

47. The apparatus of claim 45, further comprising:
i) means for maintaining a separate user data lock database separate from the first database and master database for each of the plurality of users; and
ii) means for when a user is informed that a requested data lock has been granted adding the data lock to the corresponding separate user data lock database.

48. The apparatus of step 27, wherein the data lock request includes an identification of the requesting user and the user has an associated priority and wherein the evaluation means includes:
i) means for searching the data lock database to determine whether a data lock records exists for the requested data lock wherein each data lock record includes an identification of current owner and the time the lock was granted and each current owner has an associated priority;
ii) means for determining whether the data lock record has existed for a predetermined period of time when the data lock record exists for the requested data lock;
iii) means for determining the data lock record is available when the data lock record has existed for at least the predetermined period of time
iv) means for determining whether the data lock record current owner's associated priority is less than the requesting user's associated priority when the data lock record exists for the requested data lock; and
v) means for determining the data lock record is available when the data lock record current owner's associated priority is less than the requesting user's associated priority.

49. The apparatus of claim 48, further comprising means for maintaining a separate user data lock database separate from the first database and master database for each of the plurality of users.

50. The apparatus of claim 48, further comprising means for informing the requesting user that the data lock request has been granted when it has been determined that it is available.

51. The apparatus of claim 49, further comprising means for informing the requesting user that the data lock request has been denied when it has been determined that it is not available.

52. The apparatus of claim 50, further comprising:
i) means for maintaining a separate user data lock database separate from the first database and master database for each of the plurality of users; and
ii) means for when a user is informed that a requested data lock has been granted adding the data lock to the corresponding separate user data lock database.

53. A computer readable medium encoded with data instruction for controlling access to data in a first database for a plurality of users, such that when executed by a computer is caused to perform processes comprising:
a) maintaining a master data lock database separate from the first database;
b) receiving a data lock request from one of the plurality of users;
c) evaluating the data lock database to determine whether the requested data lock is available; and
d) updating the data lock database to indicate that requesting user is the current owner of the data lock when the data lock is available.

54. The computer readable medium of claim 53, wherein evaluating the data lock database to determine whether the requested data lock is available includes searching the data lock database to determine whether a data lock records exists for the requested data lock.

55. The computer readable medium of claim 54, further comprising maintaining a separate user data lock database separate from the first database and master database for each of the plurality of users.

56. The computer readable medium of claim 54, further comprising informing the requesting user that the data lock request has been granted when it has been determined that it is available.

57. The computer readable medium of claim 55, further comprising informing the requesting user that the data lock request has been denied when it has been determined that it is not available.

58. The computer readable medium of claim 56, further comprising:
i) maintaining a separate user data lock database separate from the first database and master database for each of the plurality of users; and
ii) when a user is informed that a requested data lock has been granted adding the data lock to the corresponding separate user data lock database.

59. The computer readable medium of step 54, wherein evaluating the data lock database to determine whether the requested data lock is available includes:
i) searching the data lock database to determine whether a data lock records exists for the requested data lock;
ii) determining whether the data lock record has expired when a data lock record is present for the requested data lock; and
iii) indicating the data lock is available when the data lock record has been determined to be expired.

60. The computer readable medium of claim 59, further comprising maintaining a separate user data lock database separate from the first database and master database for each of the plurality of users.

61. The computer readable medium of claim 59, further comprising informing the requesting user that the data lock request has been granted when it has been determined that it is available.

62. The computer readable medium of claim 60, further comprising informing the requesting user that the data lock request has been denied when it has been determined that it is not available.

63. The computer readable medium of claim 61, further comprising:
i) maintaining a separate user data lock database separate from the first database and master database for each of the plurality of users; and
ii) when a user is informed that a requested data lock has been granted adding the data lock to the corresponding separate user data lock database.

64. The computer readable medium of step 53, wherein evaluating the data lock database to determine whether the requested data lock is available includes:
i) searching the data lock database to determine whether a data lock records exists for the requested data lock wherein each data lock record includes the time the lock was granted;
ii) determining whether the data lock record has existed for a predetermined period of time when the data lock record exists for the requested data lock; and
iii) determining the data lock record is available when the data lock record has existed for at least the predetermined period of time.

65. The computer readable medium of claim 64, further comprising maintaining a separate user data lock database separate from the first database and master database for each of the plurality of users.

66. The computer readable medium of claim 64, further comprising informing the requesting user that the data lock request has been granted when it has been determined that it is available.

67. The computer readable medium of claim 65, further comprising informing the requesting user that the data lock request has been denied when it has been determined that it is not available.

68. The computer readable medium of claim 66, further comprising:
i) maintaining a separate user data lock database separate from the first database and master database for each of the plurality of users; and
ii) when a user is informed that a requested data lock has been granted adding the data lock to the corresponding separate user data lock database.

69. The computer readable medium of step 53, wherein the data lock request includes an identification of the requesting user and the user has an associated priority and wherein evaluating the data lock database to determine whether the requested data lock is available includes:
i) searching the data lock database to determine whether a data lock records exists for the requested data lock wherein each data lock record includes an identification of current owner and each current owner has an associated priority;
ii) determining whether the data lock record current owner's associated priority is less than the requesting user's associated priority when the data lock record exists for the requested data lock; and
iii) determining the data lock record is available when the data lock record current owner's associated priority is less than the requesting user's associated priority.

70. The computer readable medium of claim 69, further comprising maintaining a separate user data lock database separate from the first database and master database for each of the plurality of users.

71. The computer readable medium of claim 69, further comprising informing the requesting user that the data lock request has been granted when it has been determined that it is available.

72. The computer readable medium of claim 70, further comprising informing the requesting user that the data lock request has been denied when it has been determined that it is not available.

73. The computer readable medium of claim 71, further comprising:
i) maintaining a separate user data lock database separate from the first database and master database for each of the plurality of users; and
ii) when a user is informed that a requested data lock has been granted adding the data lock to the corresponding separate user data lock database.

74. The computer readable medium of step 53, wherein the data lock request includes an identification of the requesting user and the user has an associated priority and wherein evaluating the data lock database to determine whether the requested data lock is available includes:
i) searching the data lock database to determine whether a data lock records exists for the requested data lock wherein each data lock record includes an identification of current owner and the time the lock was granted and each current owner has an associated priority;
ii) determining whether the data lock record has existed for a predetermined period of time when the data lock record exists for the requested data lock;
iii) determining the data lock record is available when the data lock record has existed for at least the predetermined period of time
iv) determining whether the data lock record current owner's associated priority is less than the requesting user's associated priority when the data lock record exists for the requested data lock; and
v) determining the data lock record is available when the data lock record current owner's associated priority is less than the requesting user's associated priority.

75. The computer readable medium of claim 74, further comprising maintaining a separate user data lock database separate from the first database and master database for each of the plurality of users.

76. The computer readable medium of claim 74, further comprising informing the requesting user that the data lock request has been granted when it has been determined that it is available.

77. The computer readable medium of claim 75, further comprising informing the requesting user that the data lock request has been denied when it has been determined that it is not available.

78. The computer readable medium of claim 76, further comprising:
i) maintaining a separate user data lock database separate from the first database and master database for each of the plurality of users; and
ii) when a user is informed that a requested data lock has been granted adding the data lock to the corresponding separate user data lock database.
